(19) United States
(12) Patent Application Publication
(10) Pub. No.: US 2023/0333998 A1
(43) Pub. Date: Oct. 19, 2023

(54) INSTRUCTION SET ARCHITECTURE SUPPORT FOR CONDITIONAL DIRECT MEMORY ACCESS DATA MOVEMENT OPERATIONS

(71) Applicant: Intel Corporation, Santa Clara, CA (US)

(72) Inventors: Shruti Sharma, Beaverton, OR (US); Robert Pawlowski, Beaverton, OR (US); Fabio Checconi, Fremont, CA (US); Jesmin Jahan Tithi, San Jose, CA (US)

(21) Appl. No.: 18/312,752

(22) Filed: May 5, 2023

Related U.S. Application Data
(60) Provisional application No. 63/488,679, filed on Mar. 6, 2023.

(51) Int. Cl. G06F 13/28

(52) U.S. Cl. CPC G06F 13/28

(57) ABSTRACT

Systems, apparatuses and methods may provide for technology that includes a plurality of memory engines corresponding to a plurality of pipelines, wherein each memory engine in the plurality of memory engines is adjacent to a pipeline in the plurality of pipelines, and wherein a first memory engine is to request one or more direct memory access (DMA) operations associated with a first pipeline, and a plurality of operation engines corresponding to a plurality of dynamic random access memories (DRAMs), wherein each operation engine in the plurality of operation engines is adjacent to a DRAM in the plurality of DRAMs, and wherein one or more of the plurality of operation engines is to conduct the one or more DMA operations based on one or more bitmaps.

### CROSS-REFERENCE TO RELATED APPLICATIONS

The present application claims the benefit of priority to U.S. Provisional Patent Application No. 63/488,679, filed on Mar. 6, 2023.

### GOVERNMENT LICENSE RIGHTS

This invention was made with government support under W911NF22C0081-0103 awarded by the Office of the Director of National Intelligence—AGILE. The government has certain rights in the invention.

### TECHNICAL FIELD

Embodiments generally relate to direct memory access (DMA) operations. More particularly, embodiments relate to instruction set architecture (ISA) support for conditional DMA data movement operations.

### BACKGROUND

For applications in which read/write operations are based on an IF condition, it may be difficult to use DMA operations because the data is loaded/stored only conditionally. When all data is local, standard systems can still pre-load the data optimistically and if the condition was false, the bandwidth gets wasted. It is more problematic if the data is remote, since retrieving remote data and then wasting the data is much costlier.

### BRIEF DESCRIPTION OF THE DRAWINGS

The various advantages of the embodiments will become apparent to one skilled in the art by reading the following specification and appended claims, and by referencing the following drawings, in which:

FIG. 1A is a slice diagram of an example of a memory system according to an embodiment;

FIG. 1B is a tile diagram of an example of a memory system according to an embodiment;

FIG. 2 is a flowchart of an example of a method of operating a performance-enhanced memory system according to an embodiment;

FIG. 3 is a flowchart of an example of a method of conducting atomic operations in a performance-enhanced memory system according to an embodiment;

FIG. 4 is a flowchart of an example of a more detailed method of operating a performance-enhanced memory system according to an embodiment;

FIG. 5 is a block diagram of an example of a gather operation according to an embodiment;

FIG. 6 is an illustration of an example of a pseudocode listing to conduct gather operations according to an embodiment;

FIG. 7 is a block diagram of an example of a scatter operation according to an embodiment;

FIG. 8 is an illustration of an example of a pseudocode listing to conduct scatter operations according to an embodiment;

FIG. 9 is a block diagram of an example of a broadcast operation according to an embodiment;

FIG. 10 is an illustration of an example of a pseudocode listing to conduct broadcast operations according to an embodiment;

FIG. 11 is a block diagram of an example of a performance-enhanced computing system according to an embodiment;

FIG. 12 is an illustration of an example of a semiconductor package apparatus according to an embodiment;

FIG. 13 is a block diagram of an example of a processor according to an embodiment; and

FIG. 14 is a block diagram of an example of a multi-processor based computing system according to an embodiment.

### DETAILED DESCRIPTION

The pattern of wasted data during conditional direct memory access (DMA) operations may appear in many graph neural network procedures such as BFS (breadth first search), page rank, random walk, etc. In those cases, generating a bitmask ahead of time and passing the bitmasks during the DMA operation may be advantageous and can overcome latency hurdles and wastage of bandwidth.

Traditional approaches to using bitmasks to conditionally move data as part of sparse DMA gather operations (“gathers”), scatter operations (“scatters”) and broadcast operations (“broadcasts”) may typically be software focused. Software implementations on cache-based architectures may lead to performance inefficiencies that are commonly seen for graph analytics on larger sparse datasets. Sequential accesses into dense data structures (e.g., index arrays and packed data arrays) may not suffer when operating through the cache. Because of the low spatial and temporal locality of randomly accessed sparse data, however, cache line utilization may suffer significantly, disproportionately affecting overall miss rates and performance. This behavior can become more prominent as dataset sizes further increase, and distributed memory architectures are used to grow the overall memory capacity of the system. As a result, cache misses become even more costly as data is fetched from a socket at the far end of the system.

There may be no dedicated hardware solutions for manipulating these data structures. The technology described herein details the instruction set architecture (ISA) and architectural support for direct memory operations that conditionally execute operations on graph data structures based on a user-provided bitmask. Embodiments use near-memory compute capability and provide full hardware support to execute functions such as conditionally gathering random data to a packed buffer, conditionally scattering values from a source buffer to random destinations, and conditionally broadcasting a scalar value to various random destinations.

Providing entire conditional gather, scatter, and broadcast operations as an ISA enables improved software efficiency. Additionally, the implementation is conducted outside of the core cache hierarchy to enable improved efficiency through improved memory and network bandwidth utilization. The use of near-memory compute reduces total latency by eliminating extra network traversals and taking the shortest total path to all physical memory locations involved in the operation. Finally, the conditional aspect of the operations enables further efficiency by moving only the appropriate elements, resulting in improved storage efficiency, and reducing any wasted memory and network bandwidth utilization.

The technology described herein may include hardware near the core pipelines to generate individual memory requests. Additionally, hardware physically near the memory controllers can be added for the near-memory compute capabilities. In addition, monitoring memory traffic patterns may reflect the DMA and near-memory compute engine access and data behavior as described herein. Moreover, hardware and programmer specifications may include any related ISA similar to what is proposed in embodiments.

A memory system (e.g., Transactional Integrated Global-memory system with Dynamic Routing and End-to-end flow control/TIGRE system) as described herein has the capability of performing direct memory access (DMA) operations designed to address common data movement primitives used in graph procedures. Data movement is allowed across all memory endpoints visible via a 64-bit Global Address Space (GAS) address map. Storage in the TIGRE system includes static random access memory (SRAM) scratchpad shared across multiple pipelines (e.g., eight pipelines) in a TIGRE slice and multiple DRAM channels (e.g., sixteen DRAM channels) that are part of a TIGRE tile. As the system scales out, multiple tiles comprise a TIGRE socket, and the socket count increases to expand the full system.

TIGRE implements conditional data movement DMA operations for gathering the data (e.g., DMA masked gather), scattering the data (e.g., DMA masked scatter), and broadcasting scalar data (e.g., DMA masked “bcast”) across memory endpoints. Implementing conditional data movement operations involves a system of DMA engines including pipeline-local Memory Engines (MENG), and near memory sub-Operation Engines (OPENG) at all memory endpoints in the system. An optional atomic operation can be applied at the destination location for each data item, in which case a near-memory Atomic Unit (ATMU) can be used.

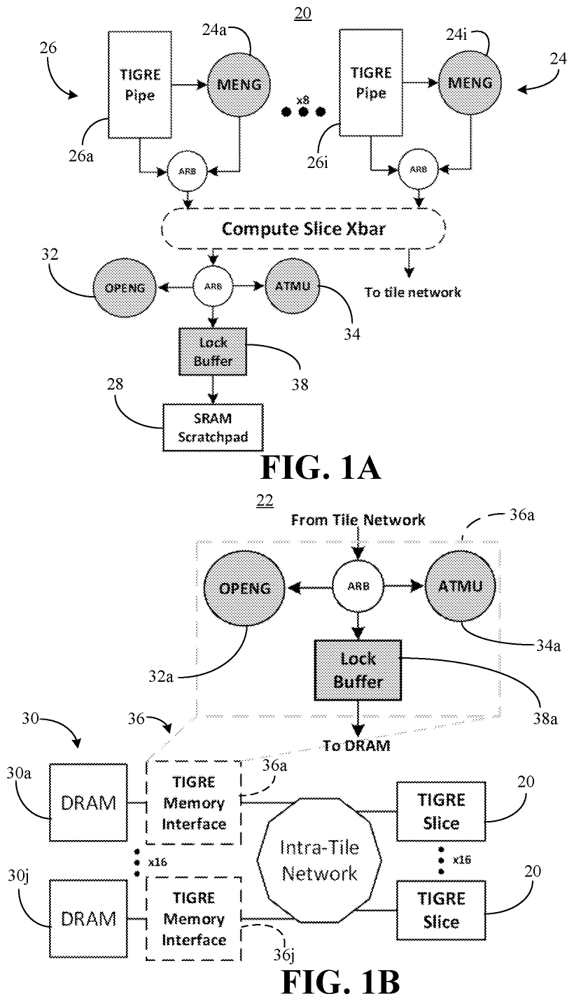

Turning now to FIGS. 1A, a TIGRE slice 20 diagram and a TIGRE tile 22 diagram are shown, respectively. FIGS. 1A and 1B show the lowest levels of the hierarchy of the TIGRE system. More particularly, the TIGRE slice 20 includes a plurality of memory engines 24 (24a-24i) corresponding to a plurality of pipelines 26 (26a-26i), wherein each memory engine 24 is adjacent to a pipeline in the plurality of pipelines 26. Each TIGRE pipeline 26 offloads DMA operations (e.g., exposed in the ISA) to a local memory engine 24 (MENG). In the illustrated example, eight of the TIGRE pipelines 26 are co-located with a shared cache (not shown) and a local SRAM scratchpad 28 to create the TIGRE slice 20. The illustrated TIGRE tile 22 includes eight slices 20—e.g., sixty-four pipelines 26 and sixteen local DRAM channels 30 (30a-30j).

Specifically, the DMA subsystem hardware is made of up units that are local to the pipeline 26 as well as in front of all scratchpad 28 and DRAM channel 30 interfaces.

The memory engines 24 (MENGs) receive DMA requests from the local pipeline 26 and initiate the operation. For example, a first MENG 24a is responsible for requesting one or more DMA operations associated with a first pipeline 26a. Thus, the first MENG 24a sends out remote load-stores, direct or indirect, with or without an atomic operation. The first MENG 24a tracks the remote load stores sent and waits for all the responses to return before sending a final response back to the first pipeline 26a.

The operation engines 32 (32a-32j, not shown, e.g., OPENGs) are positioned adjacent to memory interfaces 36 (36a-36j) and receive the load-store requests from the MENGs 24. The OPENGs 32 are responsible for performing the actual memory load-store, converting stored pointer values to physical addresses, and sending a follow-on load/store or atomic request if appropriate. Details pertaining to the role of the OPENGs 32 in the conditional DMA operations are provided below.

Atomic units 34 (e.g., 34a-34j, not shown, e.g., ATMUs) are positioned adjacent to the memory interfaces 36 and are used optionally if an atomic operation is requested at the source or destination data location. The ATMUs 34 receive the atomic request from the OPENGs 32 and can perform integer and floating-point operations on destination data. The ATMUs 34 are used in conjunction with lock buffers 38 (38a-38j, not shown) to perform the atomic operations.

The lock buffers 38 are positioned in front of the memory port and maintain line-lock status for memory addresses. Each lock buffer 38 is a multi-entry buffer that allows for multiple locked addresses in parallel per memory interface, supports 64B or 8B requests, handles partial line updates and write-combining for partial stores, and supports ‘read-lock’ and ‘write-unlock’ requests within atomic operations (“atomics”). The lock buffers 38 double as a small cache to allow fast access to bitmap data for masking operation involved in conditional DMA data movement operations.

The following discussion addresses each aspect of the TIGRE remote DMA conditional data movement operations beginning with the ISA descriptions and pipeline behavior, and then addresses the operations of the MENG 24, OPENG 32 and ATMU 34.

### TIGRE Conditional Data Movement DMA ISA and Pipeline Support

Table I lists the Conditional Data Movement DMA instructions included as part of the TIGRE ISA. The instruction is issued from the pipeline 26 to the corresponding local MENG 24. The MENG 24 uses OPENG 32 units located next to the source and destination memory ports to complete the DMA operation. If an atomic operation is requested at the destination memory location, the OPENG 32 issues a request to the ATMU 34 adjacent to the destination memory port.

TABLE I
TIGRE Conditional Data Movement DMA ISA

| Instruction | Assembly Code for Arguments |
|---|---|
| dma.mgather | R1, r2, r3, r4, r5, DMA_type, SIZE |
| (DMA masked | R1 = Destination Address |
| gather) | R2 = Source Address/gather list (Array of pointers |
| | “or” Array of offsets) |
| | R3 = Count |
| | R4 = Source Bitmap Address for Masking |
| | R5 = Base Address used for base-offset mode |
| | DMA_type = opcode, optype information |
| dma.mscatter | R1, r2, r3, r4, r5, DMA_type, SIZE |
| (DMA masked | R1 = Destination Address/Scatter list (Array of pointers |
| Scatter) | “or” Array of offsets) |
| | R2 = Source Address |
| | R3 = Count |
| | R4 = Source Bitmap Address for Masking |
| | R5 = Base Address for base-offset mode |
| | DMA_type = opcode, optype information |
| dma.mbcast | R1, r2, r3, r4, r5, DMA_type, SIZE |
| (DMA masked | R1 = Destination Address/bcast list (Array of pointers |
| broadcast) | “or” Array of offsets) |
| | R2 = Value to Broadcast |
| | R3 = Count |
| | R4 = Source Bitmap Address for Masking |
| | R5 = Base Address for base-offset mode |
| | DMA_type = opcode, optype information |

Table II lists the optional atomic operations allowed at the destination. The atomic operation to be performed is mentioned as part of DMA-Type in ISA instruction. To perform the atomic operation at the destination, the OPENG 32 loads the source data from memory and sends an atomic instruction to the ATMU 34 near the destination memory. The ATMU 34 then performs the atomic operation on the destination memory. All atomic operations can be performed with or without complimenting source data.

TABLE II
Atomic Operations for DMA masked instructions
Atomic Operation

Add (int “or” float)
Mul (int “or” float)
Max (int “or” float)
Min (int “or” float)
Compare-Overwrite
Bitwise AND/OR/XOR

### Conditional Data Movement DMA Operation

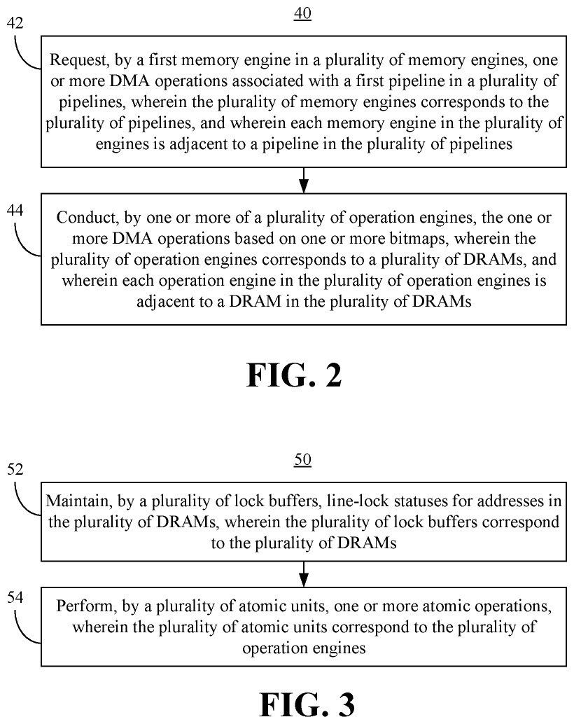

FIG. 2 shows a method 40 of operating a performance-enhanced memory system. The method 40 may generally be implemented in a memory system slice such as, for example, the slice 20 (FIG. 1A) and/or a memory system tile such as, for example, the tile 22 (FIG. 1B), already discussed. More particularly, the method 40 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 40 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 42 requests, by a first memory engine (e.g., MENG) in a plurality of memory engines, one or more DMA operations associated with a first pipeline (e.g., PIPE) in a plurality of pipelines, wherein the plurality of memory engines corresponds to the plurality of pipelines. In the illustrated example, each memory engine in the plurality of engines is adjacent to (e.g., near) a pipeline in the plurality of pipelines. In an embodiment, the DMA operation(s) include one or more of a gather operation, a scatter operation or a broadcast operation. Block 44 conducts, by one or more of a plurality of operation engines (e.g., OPENGs), the one or more DMA operations based on one or more bitmaps, wherein the plurality of operation engines corresponds to a plurality of DRAMs. In the illustrated example, each operation engine in the plurality of operation engines is adjacent to a DRAM in the plurality of DRAMs. In an embodiment, block 44 involves conditionally transferring data based on the one or more bitmaps. As will be discussed in greater detail, the one or more DMA operations can be conducted in one or more of a base plus offset mode or an address mode.

The method 40 therefore enhances performance at least to the extent that conducting the DMA operation(s) by an operation engine that is adjacent to the DRAM (e.g., near-memory compute) reduces total latency by eliminating extra network traversals and taking the shortest total path to all physical memory locations involved in the operation. Conducting the DMA operation(s) outside the core cache hierarchy also enhances efficiency through improved memory and network bandwidth utilization. Additionally, the conditional aspect of the operations further improves efficiency by moving only the appropriate elements. Such an approach results in improved storage efficiency and reduces wasted memory and network bandwidth utilization. Moreover, providing entire conditional gather, scatter, and broadcast operations as an ISA improves software efficiency.

FIG. 3 shows a method 50 of conducting atomic operations in a performance-enhanced computing system. The method 50 may generally be incorporated into block 44 (FIG. 2), already discussed. More particularly, the method 50 may be implemented in one or more modules as a set of logic instructions stored in a machine- or computer-readable storage medium such as RAM, ROM, PROM, firmware, flash memory, etc., in hardware, or any combination thereof.

Illustrated processing block 52 provides for maintaining, by a plurality of lock buffers, line-lock statuses for addresses in the plurality of DRAMs, wherein the plurality of lock buffers correspond to the plurality of DRAMs. Block 54 performs, by a plurality of atomic units, one or more atomic operations, when the plurality of atomic units correspond to the plurality of operation engines. The method 50 further enhances performance at least to the extent that using near-memory compute to perform atomic operations further reduces latency.

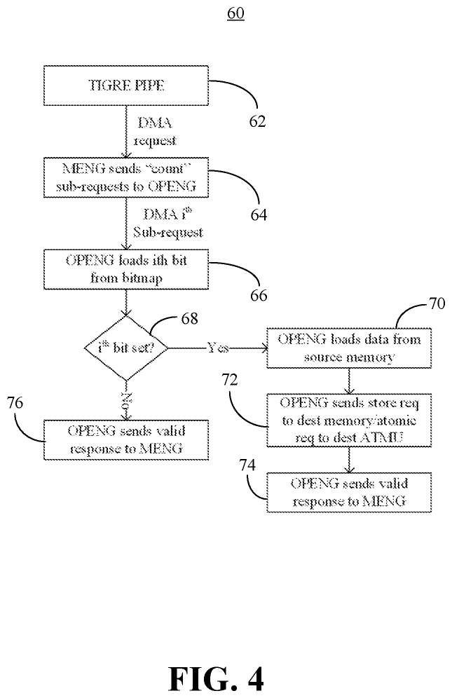

FIG. 4 shows a more detailed method 60 of operating a performance-enhanced memory system. The method 60 may generally be implemented in a memory system slice such as, for example, the slice 20 (FIG. 1A) and/or a memory system tile such as, for example, the tile 22 (FIG. 1B), already discussed. More particularly, the method 60 may be implemented in one or more modules as a set of logic instructions stored in a machine- or computer-readable storage medium such as RAM, ROM, PROM, firmware, flash memory, etc., in hardware, or any combination thereof.

The MENG receives the DMA instructions from the local pipeline at processing block 62. The MENG stores the instruction information into a local buffer slot. In processing block 64, the MENG sends out a “count” number of sub-instruction requests (e.g., one sub-instruction request per data element) each to a remote OPENG. The type of sub-instruction sent to the OPENG is dependent on the type of instruction being executed. After sending the “count” number of sub-instructions out to OPENGs, the MENG waits for the “count” number of responses. Once the MENG receives all the responses back, the MENG sends a final response back to the pipeline and the instruction is considered as complete.

The OPENG receives multiple requests from the MENG describing the operation OPENG to be performed and loads the bit from the bitmap at block 66. For conditional-data-movement DMA instructions, the OPENG uses the condition specified by a bitmap to decide the data movement. The elements from the source are copied to destination only if the corresponding bit in the bitmap is set. These instructions also make use of indirect addressing and the OPENG is responsible for performing the indirect operation by loading the address value from the memory and creating another load/store request based on the address loaded from memory. For instructions requiring atomic operations, the OPENG sends requests to the ATMU with destination address information, data value and opcode type.

The ATMU receives the atomic instruction from the OPENG if an atomic operation is to be performed at the destination. The ATMU performs the atomic operation by sending the read-lock and write-unlock instructions to memory. All ATMU accesses to memory are handled by a cached locked buffer located adjacent to the memory interface. The Lock Buffer locks an address when a locked-read request is received from the ATMU. The address is locked until ATMU sends an unlock-write request for the same address. Once the ATMU completes the operation, the ATMU sends a response packet back to the MENG.

Thus, block 68 determines whether the i^{th} bit is set. If so, the OPENG loads data from the source memory at block 70, sends a store request to the destination memory/atomic request to the destination ATMU at block 72, and sends a valid response to the MENG at block 74. If the i^{th} bit is not set, the OPENG sends a valid response to the MENG at block 76.

Each of the instructions mentioned in Table I can be operated in two pointer modes: Base+Offset Mode “or” Address Mode. The mode of operation is provided as part of a DMA-Type in an ISA instruction. For Base+Offset Mode, the gather list/scatter list/bcast list provides the list of offsets, and the addresses are calculated by adding base address with the offset values provided in the list. For Address Mode, the list provides the list of addresses. The Base Address value is not used in Address Mode. Below is a detailed description of each instruction.

### Gather Operations

dma.mgather r1, r2, r3, r4, r5, DMA_type, SIZE

R1=Destination Address, R2=Source Address/Gather list, R3=Count, R4=Source bitmap Address for Masking, R5=Base Address for Base+Offset Mode

The dma.mgather instruction conditionally gathers the data elements from addresses specified in a gather list into a contiguous array at destination address. Data is moved based on the bit values stored in a bitmap with the base address provided by the r4 operand. For any bit values in the masking bitmap equal to zero, the corresponding source value is not copied to the destination buffer. An optional atomic can be applied at the destination to each data item dependent on the DMAType input fields.

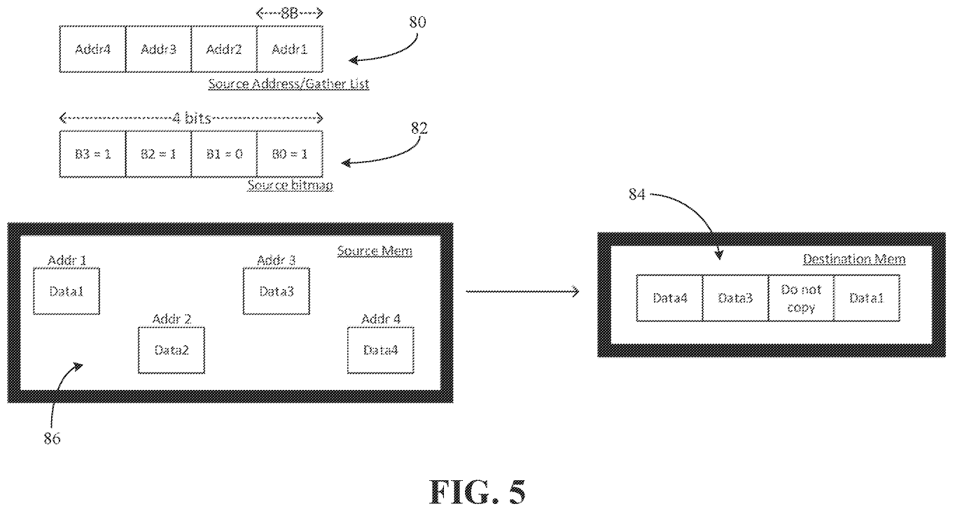

FIG. 5 shows an example of the dma.mgather operation (e.g., Dma.mgather with count=4, Mode=Address Mode). This example conditionally moves data from four (count=4) address locations given by a gather list 80 to a packed destination array. One of the bits (Bit [1]) in a source bitmap 82 is taken as zero, so no data is copied from ‘Addr2’ to a destination array 84. The destination array 84 includes a placeholder slot in the destination memory as “Do not copy” because there will be no memory allocated for this entry and no copy made to preserve write bandwidth and destination memory storage space.

The atomic opcode in this example is taken as “NONE”. Therefore, the data is copied from source addresses 86 to the destination array 84 without any additional operations. If any atomic opcode is specified in the instruction, the corresponding operation is performed between the source data value and the pre-existing data value at the respective location in the destination array 84. Because the example considers mode of addressing as “Address Mode”, the gather list 80 contains the direct addresses from where to gather the data.

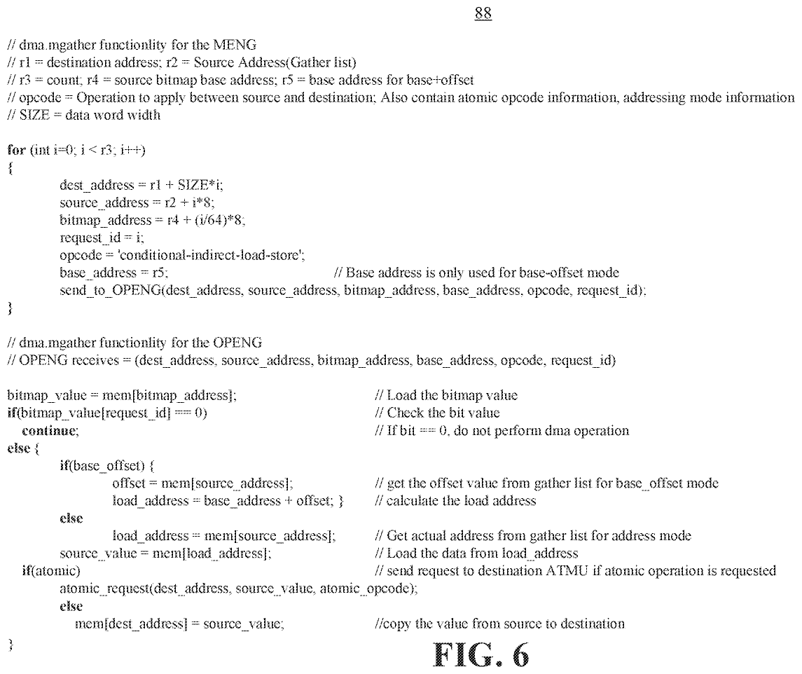

FIG. 6 shows a pseudocode listing 88 describing the functionality of both MENG and OPENG while executing the dma.mgather instruction. The MENG sends “count”(r3) number of sub-instruction-requests to one (or multiple, depending on the physical memory locations) OPENG. Each of these requests will refer to unique bits in source bitmap (e.g., given by index value) and will have a unique source address/gather list address and destination address. For each sub-instruction, the OPENG fetches the corresponding bit from the source bitmap, loads the gather list value to obtain the exact load address, conducts the load to fetch the source data and executes a store/atomic to the destination array. If the source bitmap bit is not set, the OPENG sends a valid response to MENG without performing the copy. The physical locations of the arrays in the system may vary, meaning that the sequence of operations shown for the OPENG may be executed by multiple physical OPENG units (e.g., each local to their respective data structures).

### Scatter Operations

dma.mscatter r1, r2, r3, r4, r5, DMA_type, SIZE

R1=Dest Address/Scatter list; R2=Source Address; R3=Count; R4=Source bitmap Address for Masking, R5=Base Address for Base+Offset Mode

The dma.mscatter instruction conditionally scatters the data stored in a packed source buffer to the addresses specified by a scatter list. Data is moved based on the bit values stored in a bitmap with the base address provided by the r4 operand. For any bit values in the masking bitmap equal to zero, the corresponding source value is not copied to the destination buffer. An optional atomic operation can be applied at the destination to each data item.

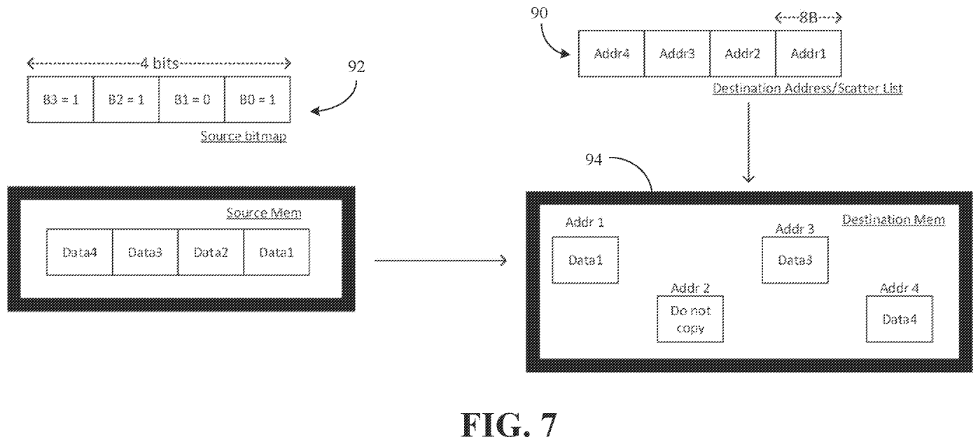

FIG. 7 shows an example of the dma.mscatter operation (e.g., Dma.mscatter with count=4, Mode=Address Mode). This example conditionally moves four (count=4) data elements from source array to corresponding addresses given by a scatter list 90. One of the bits (Bit [1]) in the source bitmap 92 is taken as zero, so data element two from the source array is not copied to Addr2. The destination memory 94 includes a placeholder slot as “Do not copy”, so there will be no memory allocated for this entry and no copy made to preserve write bandwidth and destination memory storage space.

The atomic opcode in this example is taken as “NONE”. Therefore, the data is copied from source to destination without any additional operation. If any atomic opcode is specified in the instruction, the corresponding operation is performed between the source data value and the pre-existing data value at the respective location in the destination. Because the example considers mode of addressing as “Address Mode”, the scatter list 90 contains the list of direct addresses.

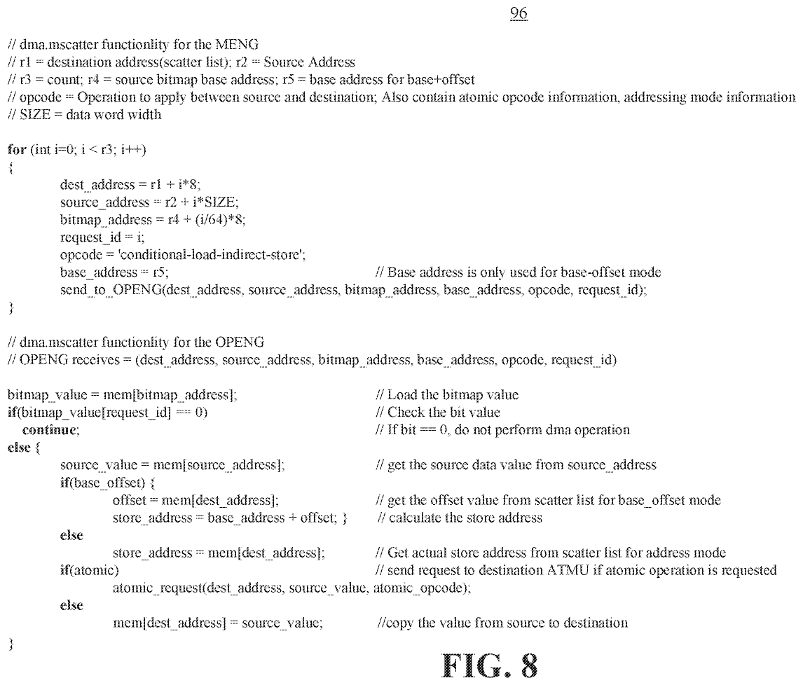

FIG. 8 shows a pseudocode listing 96 describing the functionality of both MENG and OPENG while executing the dma.mscatter instruction. The MENG sends “count”(r3) number of sub-instruction-reqs to the OPENG. Each of these requests will refer to a unique bit in the source bitmap (e.g., given by index value) and will have a unique source address and destination address/scatter list address. For each sub-instruction, the OPENG will fetch the corresponding bit from the source bitmap, load the data value from source, load the scatter list value to get the exact store address, and execute a store/atomic to the store address. If the source bitmap bit is not set, the OPENG sends a valid response to the MENG without performing the copy.

### Broadcast Operations

dma.mbcast r1, r2, r3, r4, r5, DMA_type, SIZE

R1=Dest Address/Bcast list; R2=Source value to broadcast; R3=Count; R4=Source bitmap Address for Masking, R5=Base Address for Base+Offset Mode

The dma.mbcast instruction conditionally broadcasts the scalar data (e.g., input operand r2) to the addresses specified by broadcast list (base address in r1). Data is moved based on the bit values stored in a bitmap with its base address provided by the r4 operand. For any bit values in the masking bitmap equal to zero, the input value is not written to the respective destination location. An optional atomic can be applied at destination to each data item.

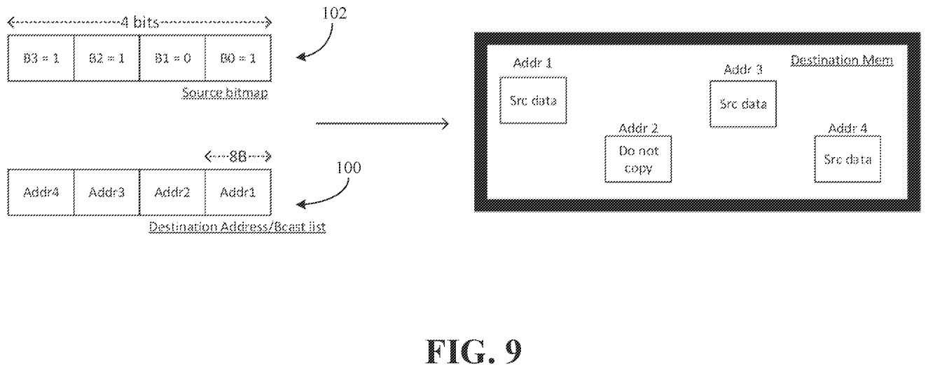

FIG. 9 shows an example of the dma.mbcast operation (Dma.mbcast with count=4, Mode=Address Mode). This example conditionally moves scalar data (r2) to four (count=4) different addresses provided by a bcast list 100. One of the bits (e.g., Bit [1]) in a source bitmap 102 is taken as zero, so source data (r2) is not copied to Addr2.

The atomic opcode in this example is taken as “NONE”. Therefore, the data is copied to destination without any additional operations. If any atomic opcode is specified in the instruction, the corresponding operation is performed between the source data value and the pre-existing data value at the respective location in the destination. Because the example considers mode of addressing as “Address Mode”, the bcast list 100 contains the list of direct addresses.

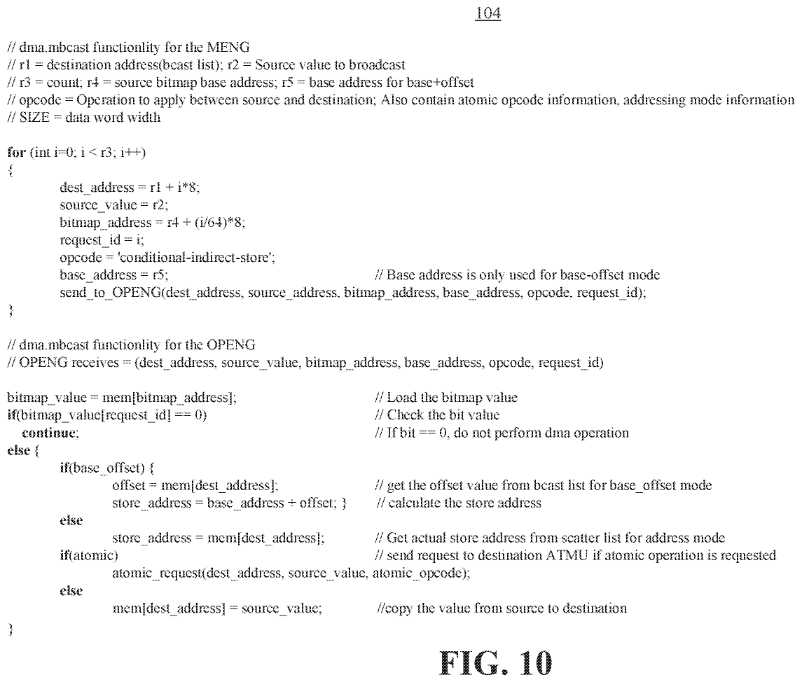

FIG. 10 shows a pseudocode listing 104 describing the functionality of both the MENG and the OPENG while executing the dma.mbcast instruction. The MENG sends “count”(r3) number of sub-instruction-reqs to the OPENG. Each of these requests will refer to a unique bit in the source bitmap (e.g., given by index value) and will have a unique destination address/bcast list address. For each sub-instruction, the OPENG will fetch the corresponding bit from the source bitmap, load the bcast list value to get the exact store address, and execute a store/atomic to the store address. If the source bitmap bit is not set, the OPENG sends a valid response to MENG without performing the copy.

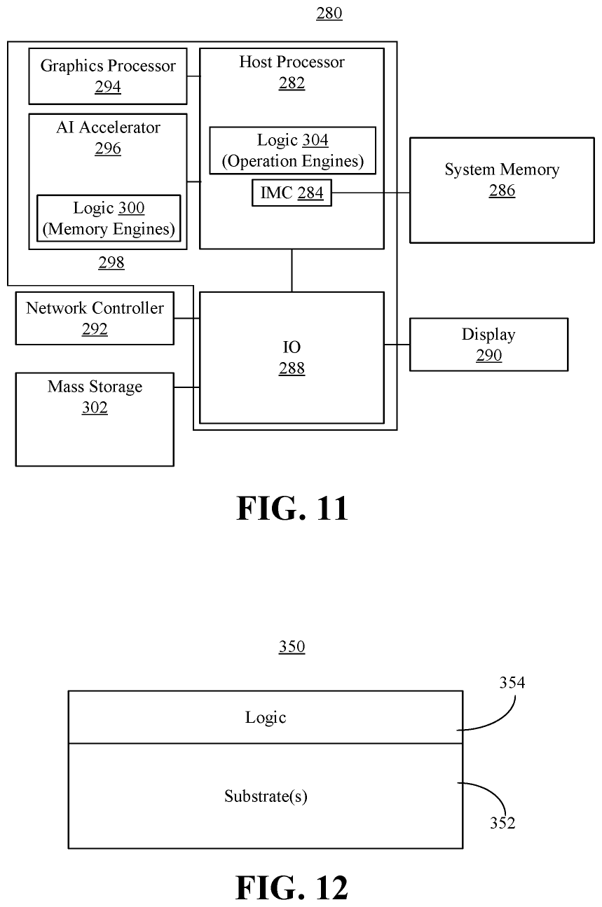

Turning now to FIG. 11, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 includes memory engine logic 300 and the host processor 282 includes operation engine logic 304, wherein the logic 300, 304 (e.g., performance-enhanced memory system) performs one or more aspects of the method 40 (FIG. 2), the method 50 (FIG. 3) and/or the method 60 (FIG. 4), already discussed. Thus, the memory engine logic 300 includes a plurality of memory engines corresponding to a plurality of pipelines (not shown), wherein each memory engine in the plurality of memory engines is adjacent to a pipeline in the plurality of pipelines. Additionally, a first memory engine is to request one or more DMA operations associated with a first pipeline. The operation engine logic 304 corresponds to a plurality of DRAMs in the system memory 286, wherein each operation engine in the plurality of operation engines is adjacent to a DRAM in the plurality of DRAMs. Additionally, one or more of the plurality of operation engines is to conduct the one or more DMA operations based on one or more bitmaps.

The computing system 280 and/or the memory system represented by the logic 300, 304 are therefore considered performance-enhanced at least to the extent that conducting the DMA operation(s) by an operation engine that is adjacent to the DRAM (e.g., near-memory compute) reduces total latency by eliminating extra network traversals and taking the shortest total path to all physical memory locations involved in the operation. Conducting the DMA operation(s) outside the core cache hierarchy also enhances efficiency through improved memory and network bandwidth utilization. Additionally, the conditional aspect of the operations further improves efficiency by moving only the appropriate elements. Such an approach results in improved storage efficiency and reduces wasted memory and network bandwidth utilization. Moreover, providing entire conditional gather, scatter, and broadcast operations as an ISA improves software efficiency.

FIG. 12 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 40 (FIG. 2), the method 50 (FIG. 3) and/or the method 60 (FIG. 4), already discussed, and may be readily substituted for the logic 300, 304 (FIG. 11), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

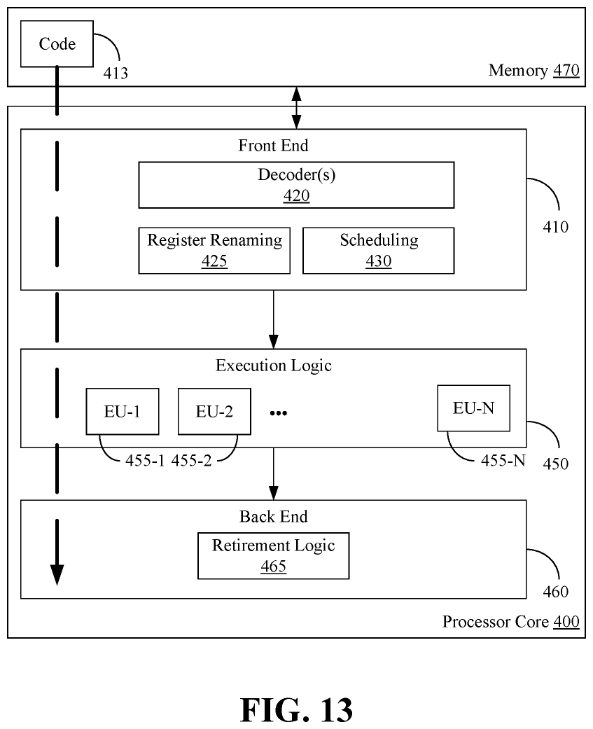

FIG. 13 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 13, a processing element may alternatively include more than one of the processor core 400 illustrated in FIG. 13. The processor core 400 may be a single-threaded core or, for at least one embodiment, the processor core 400 may be multithreaded in that it may include more than one hardware thread context (or “logical processor”) per core.

FIG. 13 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 40 (FIG. 2), the method 50 (FIG. 3) and/or the method 60 (FIG. 4), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 13, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

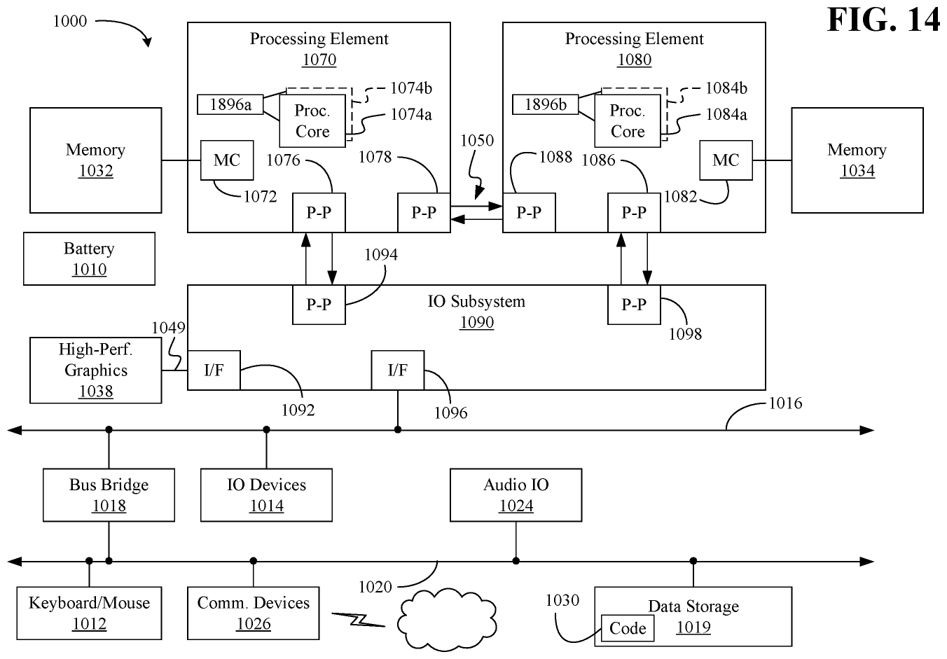

Referring now to FIG. 14, shown is a block diagram of a computing system 1000 embodiment in accordance with an embodiment. Shown in FIG. 14 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 14 may be implemented as a multi-drop bus rather than point-to-point interconnect.

As shown in FIG. 14, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 13.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 14, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 14, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 14, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 40 (FIG. 2), the method 50 (FIG. 3) and/or the method 60 (FIG. 4), already discussed. Further, an audio I/O 1024 may be coupled to second bus 1020 and a battery 1010 may supply power to the computing system 1000.

Note that other embodiments are contemplated. For example, instead of the point-to-point architecture of FIG. 14, a system may implement a multi-drop bus or another such communication topology. Also, the elements of FIG. 14 may alternatively be partitioned using more or fewer integrated chips than shown in FIG. 14.

### Additional Notes and Examples

Example 1 includes a performance-enhanced computing system comprising a network controller, a plurality of dynamic random access memories (DRAMs), and a processor coupled to the network controller, the processor including logic coupled to one or more substrates, wherein the logic includes a plurality of memory engines corresponding to a plurality of pipelines, wherein each memory engine in the plurality of memory engines is adjacent to a pipeline in the plurality of pipelines, and wherein a first memory engine is to request one or more direct memory access (DMA) operations associated with a first pipeline, and a plurality of operation engines corresponding to the plurality of DRAMs, wherein each operation engine in the plurality of operation engines is adjacent to a DRAM in the plurality of DRAMs, and wherein one or more of the plurality of operation engines is to conduct the one or more DMA operations based on one or more bitmaps.

Example 2 includes the computing system of Example 1, wherein the one or more of the plurality of operation engines is to conditionally transfer data based on the one or more bitmaps.

Example 3 includes the computing system of Example 1, wherein the one or more DMA operations include one or more of a gather operation, a scatter operation or a broadcast operation.

Example 4 includes the computing system of Example 1, wherein the one or more DMA operations are conducted in one or more of a base plus offset mode or an address mode.

Example 5 includes the computing system of any one of Examples 1 to 4, wherein the logic further includes a plurality of lock buffers corresponding to the plurality of DRAMs, wherein the plurality of lock buffers are to maintain line-lock statuses for addresses in the plurality of DRAMs, and a plurality of atomic units corresponding to the plurality of operation engines, wherein the plurality of atomic units are to perform one or more atomic operations.

Example 6 includes a semiconductor apparatus comprising one or more substrates, and logic coupled to the one or more substrates, wherein the logic is implemented at least partly in one or more of configurable or fixed-functionality hardware, the logic including a plurality of memory engines corresponding to a plurality of pipelines, wherein each memory engine in the plurality of memory engines is adjacent to a pipeline in the plurality of pipelines, and wherein a first memory engine is to request one or more direct memory access (DMA) operations associated with a first pipeline, and a plurality of operation engines corresponding to a plurality of dynamic random access memories (DRAMs), wherein each operation engine in the plurality of operation engines is adjacent to a DRAM in the plurality of DRAMs, and wherein one or more of the plurality of operation engines is to conduct the one or more DMA operations based on one or more bitmaps.

Example 7 includes the semiconductor apparatus of Example 6, wherein the one or more of the plurality of operation engines is to conditionally transfer data based on the one or more bitmaps.

Example 8 includes the semiconductor apparatus of Example 6, wherein the one or more DMA operations include one or more of a gather operation, a scatter operation or a broadcast operation.

Example 9 includes the semiconductor apparatus of Example 6, wherein the one or more DMA operations are conducted in one or more of a base plus offset mode or an address mode.

Example 10 includes the semiconductor apparatus of any one of Examples 6 to 9, wherein the logic further includes a plurality of lock buffers corresponding to the plurality of DRAMs, wherein the plurality of lock buffers are to maintain line-lock statuses for addresses in the plurality of DRAMs, and a plurality of atomic units corresponding to the plurality of operation engines, wherein the plurality of atomic units are to perform one or more atomic operations.

Example 11 includes at least one computer readable storage medium comprising a set of instructions, which when executed by a computing system, cause the computing system to request, by a first memory engine in a plurality of memory engines, one or more direct memory access (DMA) operations associated with a first pipeline in a plurality of pipelines, wherein the plurality of memory engines corresponds to the plurality of pipelines, and wherein each memory engine in the plurality of engines is adjacent to a pipeline in the plurality of pipelines, and conduct, by one or more of a plurality of operation engines, the one or more DMA operations based on one or more bitmaps, wherein the plurality of operation engines corresponds to a plurality of dynamic random access memories (DRAMs), and wherein each operation engine in the plurality of operation engines is adjacent to a DRAM in the plurality of DRAMs.

Example 12 includes the at least one computer readable storage medium of Example 11, wherein the instructions, when executed, further cause the computing system to conditionally transfer, by the one or more of the plurality of operation engines, data based on the one or more bitmaps.

Example 13 includes the at least one computer readable storage medium of Example 11, wherein the one or more DMA operations include one or more of a gather operation, a scatter operation or a broadcast operation.

Example 14 includes the at least one computer readable storage medium of Example 11, wherein the one or more DMA operations are conducted in one or more of a base plus offset mode or an address mode.

Example 15 includes the at least one computer readable storage medium of any one of Examples 11 to 14, wherein the instructions, when executed, further cause the computing system to maintain, by a plurality of lock buffers, line-lock statuses for addresses in the plurality of DRAMs, wherein the plurality of lock buffers correspond to the plurality of DRAMs, and perform, by a plurality of atomic units, one or more atomic operations, wherein the plurality of atomic units correspond to the plurality of operation engines.

Example 16 includes a method of operating a performance-enhanced computing system, the method comprising requesting, by a first memory engine in a plurality of memory engines, one or more direct memory access (DMA) operations associated with a first pipeline in a plurality of pipelines, wherein the plurality of memory engines corresponds to the plurality of pipelines, and wherein each memory engine in the plurality of engines is adjacent to a pipeline in the plurality of pipelines, and conducting, by one or more of a plurality of operation engines, the one or more DMA operations based on one or more bitmaps, wherein the plurality of operation engines corresponds to a plurality of dynamic random access memories (DRAMs), and wherein each operation engine in the plurality of operation engines is adjacent to a DRAM in the plurality of DRAMs.

Example 17 includes the method of Example 16, further including conditionally transferring, by the one or more of the plurality of operation engines, data based on the one or more bitmaps.

Example 18 includes the method of Example 16, wherein the one or more DMA operations include one or more of a gather operation, a scatter operation or a broadcast operation.

Example 19 includes the method of Example 16, wherein the one or more DMA operations are conducted in one or more of a base plus offset mode or an address mode.

Example 20 includes the method of any one of Examples 16 to 19, further including maintaining, by a plurality of lock buffers, line-lock statuses for addresses in the plurality of DRAMs, wherein the plurality of lock buffers correspond to the plurality of DRAMs, and performing, by a plurality of atomic units, one or more atomic operations, wherein the plurality of atomic units correspond to the plurality of operation engines.

Example 21 includes an apparatus comprising means for performing the method of any one of Examples 16 to 20.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 140 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Moreover, a semiconductor apparatus (e.g., chip, die, package) can include one or more substrates (e.g., silicon, sapphire, gallium arsenide) and logic (e.g., circuitry, transistor array and other integrated circuit/IC components) coupled to the substrate(s), wherein the logic implements one or more aspects of the methods described herein. The logic may be implemented at least partly in configurable or fixed-functionality hardware. In one example, the logic includes transistor channel regions that are positioned (e.g., embedded) within the substrate(s). Thus, the interface between the logic and the substrate(s) may not be an abrupt junction. The logic may also be considered to include an epitaxial layer that is grown on an initial wafer of the substrate(s).

We claim:

1. A computing system comprising:
a network controller;
a plurality of dynamic random access memories (DRAMs); and
a processor coupled to the network controller, the processor including logic coupled to one or more substrates, wherein the logic includes:
a plurality of memory engines corresponding to a plurality of pipelines, wherein each memory engine in the plurality of memory engines is adjacent to a pipeline in the plurality of pipelines, and wherein a first memory engine is to request one or more direct memory access (DMA) operations associated with a first pipeline, and
a plurality of operation engines corresponding to the plurality of DRAMs, wherein each operation engine in the plurality of operation engines is adjacent to a DRAM in the plurality of DRAMs, and wherein one or more of the plurality of operation engines is to conduct the one or more DMA operations based on one or more bitmaps.

2. The computing system of claim 1, wherein the one or more of the plurality of operation engines is to conditionally transfer data based on the one or more bitmaps.

3. The computing system of claim 1, wherein the one or more DMA operations include one or more of a gather operation, a scatter operation or a broadcast operation.

4. The computing system of claim 1, wherein the one or more DMA operations are conducted in one or more of a base plus offset mode or an address mode. includes:

5. The computing system of claim 1, wherein the logic further
a plurality of lock buffers corresponding to the plurality of DRAMs, wherein the plurality of lock buffers are to maintain line-lock statuses for addresses in the plurality of DRAMs; and
a plurality of atomic units corresponding to the plurality of operation engines, wherein the plurality of atomic units are to perform one or more atomic operations.

6. A semiconductor apparatus comprising:
one or more substrates; and
logic coupled to the one or more substrates, wherein the logic is implemented at least partly in one or more of configurable or fixed-functionality hardware, the logic including:
a plurality of memory engines corresponding to a plurality of pipelines, wherein each memory engine in the plurality of memory engines is adjacent to a pipeline in the plurality of pipelines, and wherein a first memory engine is to request one or more direct memory access (DMA) operations associated with a first pipeline; and
a plurality of operation engines corresponding to a plurality of dynamic random access memories (DRAMs), wherein each operation engine in the plurality of operation engines is adjacent to a DRAM in the plurality of DRAMs, and wherein one or more of the plurality of operation engines is to conduct the one or more DMA operations based on one or more bitmaps.

7. The semiconductor apparatus of claim 6, wherein the one or more of the plurality of operation engines is to conditionally transfer data based on the one or more bitmaps.

8. The semiconductor apparatus of claim 6, wherein the one or more DMA operations include one or more of a gather operation, a scatter operation or a broadcast operation.

9. The semiconductor apparatus of claim 6, wherein the one or more DMA operations are conducted in one or more of a base plus offset mode or an address mode.

10. The semiconductor apparatus of claim 6, wherein the logic further includes:
a plurality of lock buffers corresponding to the plurality of DRAMs, wherein the plurality of lock buffers are to maintain line-lock statuses for addresses in the plurality of DRAMs; and
a plurality of atomic units corresponding to the plurality of operation engines, wherein the plurality of atomic units are to perform one or more atomic operations.

11. At least one computer readable storage medium comprising a set of instructions, which when executed by a computing system, cause the computing system to:
request, by a first memory engine in a plurality of memory engines, one or more direct memory access (DMA) operations associated with a first pipeline in a plurality of pipelines, wherein the plurality of memory engines corresponds to the plurality of pipelines, and wherein each memory engine in the plurality of engines is adjacent to a pipeline in the plurality of pipelines; and
conduct, by one or more of a plurality of operation engines, the one or more DMA operations based on one or more bitmaps, wherein the plurality of operation engines corresponds to a plurality of dynamic random access memories (DRAMs), and wherein each operation engine in the plurality of operation engines is adjacent to a DRAM in the plurality of DRAMs.

12. The at least one computer readable storage medium of claim 11, wherein the instructions, when executed, further cause the computing system to conditionally transfer, by the one or more of the plurality of operation engines, data based on the one or more bitmaps.

13. The at least one computer readable storage medium of claim 11, wherein the one or more DMA operations include a gather operation.

14. The at least one computer readable storage medium of claim 11, wherein the one or more DMA operations include a scatter operation.

15. The at least one computer readable storage medium of claim 11, wherein the one or more DMA operations include a broadcast operation.

16. The at least one computer readable storage medium of claim 11, wherein the one or more DMA operations are conducted in a base plus offset mode.

17. The at least one computer readable storage medium of claim 11, wherein the one or more DMA operations are conducted in an address mode.

18. The at least one computer readable storage medium of claim 11, wherein the instructions, when executed, further cause the computing system to maintain, by a plurality of lock buffers, line-lock statuses for addresses in the plurality of DRAMs.

19. The at least one computer readable storage medium of claim 18, wherein the plurality of lock buffers correspond to the plurality of DRAMs.

20. The at least one computer readable storage medium of claim 18, wherein the instructions, when executed, further cause the computing system to perform, by a plurality of atomic units, one or more atomic operations, wherein the plurality of atomic units correspond to the plurality of operation engines.
